(19) United States
(12) Patent Application Publication
(10) Pub. No.: US 2024/0171538 A1
(43) Pub. Date: May 23, 2024

(54) SOCIAL CLUB FEATURES IN AN ONLINE DISCUSSION FORUM

(71) Applicant: Alpha Exploration Co. d/b/a Clubhouse, San Francisco, CA (US)

(72) Inventors: Patrick Underwood, San Francisco, CA (US); Aaron Sittig, San Francisco, CA (US); Paul Davison, San Francisco, CA (US); Rohan Seth, San Francisco, CA (US); Mohammad Almalkawi, San Francisco, CA (US); Kenny D'Amica, San Francisco, CA (US)

(73) Assignee: Alpha Exploration Co. d/b/a Clubhouse, San Francisco, CA (US)

(21) Appl. No.: 17/992,746

(22) Filed: Nov. 22, 2022

(51) Int. Cl. H04L 51/52; G06Q 50/00

(52) U.S. Cl. CPC H04L 51/52; G06Q 50/01

(57) ABSTRACT

A method for operating a social club within an online discussion forum. The method includes receiving at least one first parameter for the social club, establishing, at a first time, the social club with a configuration based on the at least one first parameter, determining, at a second time, a member count of the social club, comparing the member count to at least one threshold, automatically selecting at least one second parameter for the social club based on a result of the comparison, and updating the configuration of the social club based on the at least one second parameter.

### TECHNICAL FIELD

This specification relates to online discussion forums and, in particular, to online audio discussion forums in which users participate as speakers and audience members in virtual audio rooms.

### BACKGROUND

An online discussion forum such as a message board, or a social media website, provides an online forum where users can hold discussions by posting messages. In message boards, text-based messages posted for a particular topic can be grouped into a thread, often referred to as a conversation thread. A user interface (e.g., a web page) for an online forum can contain a list of threads or topics. In social media websites, users are typically followed by other users and/or select other users to follow. In this context, “follow” means being able to see content posted by the followed user. Users typically select other users to follow based on the identity of the other users, which is provided by the social media platform, e.g., by providing a real name, a user name, and/or a picture. However, text-based online discussion forums and social media websites can have slow moving discussions where messages or posts are exchanged over long periods of time (hours, days, etc.). Such text-based online discussions can also sometimes fail to capture nuances in tone and emotion that in-person or telephone discussion can. As such, these online discussions can be less interactive, dynamic, and intimate relative to in-person discussions or telephone discussions.

### SUMMARY

At least one aspect of the present disclosure is directed to a method for operating a social club within an online discussion forum. The method includes receiving at least one first parameter for the social club, establishing, at a first time, the social club with a configuration based on the at least one first parameter, determining, at a second time, a member count of the social club, comparing the member count to at least one threshold, automatically selecting at least one second parameter for the social club based on a result of the comparison, and updating the configuration of the social club based on the at least one second parameter.

Another aspect of the present disclosure is directed to a system for operating a social club within an online discussion forum. The system includes at least one memory for storing computer-executable instructions and at least one processor for executing the instructions stored on the memory. When executed, the instructions program the at least one processor to perform operations that include receiving at least one first parameter for the social club, establishing, at a first time, the social club with a configuration based on the at least one first parameter, determining, at a second time, a member count of the social club, comparing the member count to at least one threshold, automatically selecting at least one second parameter for the social club based on a result of the comparison, and updating the configuration of the social club based on the at least one second parameter.

Another aspect of the present disclosure is directed to a method for operating a social club within an online discussion forum. The method includes sending invites to a first cohort of users to join the social club, the first cohort of users being selected by at least one creator of the social club, receiving an acceptance of the invite to join the social club from one or more users of the first cohort of users, allocating, upon acceptance of the invite, a first predetermined number of invites to each user of the first cohort of users, and sending invites to a second cohort of users to join the social club, the second cohort of users being selected by the one or more users of the first cohort of users who joined the social club.

Another aspect of the present disclosure is directed to a system for operating a social club within an online discussion forum. The system includes at least one memory for storing computer-executable instructions and at least one processor for executing the instructions stored on the memory. When executed, the instructions program the at least one processor to perform operations that include sending invites to a first cohort of users to join the social club, the first cohort of users being selected by at least one creator of the social club, receiving an acceptance of the invite to join the social club from one or more users of the first cohort of users, allocating, upon acceptance of the invite, a first predetermined number of invites to each user of the first cohort of users, and sending invites to a second cohort of users to join the social club, the second cohort of users being selected by the one or more users of the first cohort of users who joined the social club.

### BRIEF DESCRIPTION OF THE DRAWINGS

FIG. 1 illustrates a block diagram of a system for providing online audio discussion forums in accordance with aspects described herein;

FIG. 2 illustrates a user interface of a client application in accordance with aspects described herein;

FIG. 3 illustrates a user interface of a client application in accordance with aspects described herein;

FIG. 4 illustrates a flow diagram of a method for creating a House in accordance with aspects described herein;

FIG. 5 illustrates a user interface of a client application in accordance with aspects described herein;

FIG. 6 illustrates a user interface of a client application in accordance with aspects described herein;

FIGS. 7A, 7B illustrate a user interface of a client application in accordance with aspects described herein;

FIGS. 8A, 8B illustrate a user interface of a client application in accordance with aspects described herein;

FIGS. 9A, 9B, 9C illustrate a user interface of a client application in accordance with aspects described herein;

FIG. 10 illustrates a diagram of an invite system in accordance with aspects described herein;

FIG. 11 illustrates a user interface of a client application in accordance with aspects described herein;

FIG. 12 illustrates a flow diagram of a method for dynamically scaling a House in accordance with aspects described herein;

FIG. 13 illustrates a flow diagram of a method for dynamically scaling a House in accordance with aspects described herein;

FIG. 14 illustrates a flow diagram of a method for dynamically scaling a House in accordance with aspects described herein; and

FIG. 15 illustrates an example computing device.

### DETAILED DESCRIPTION

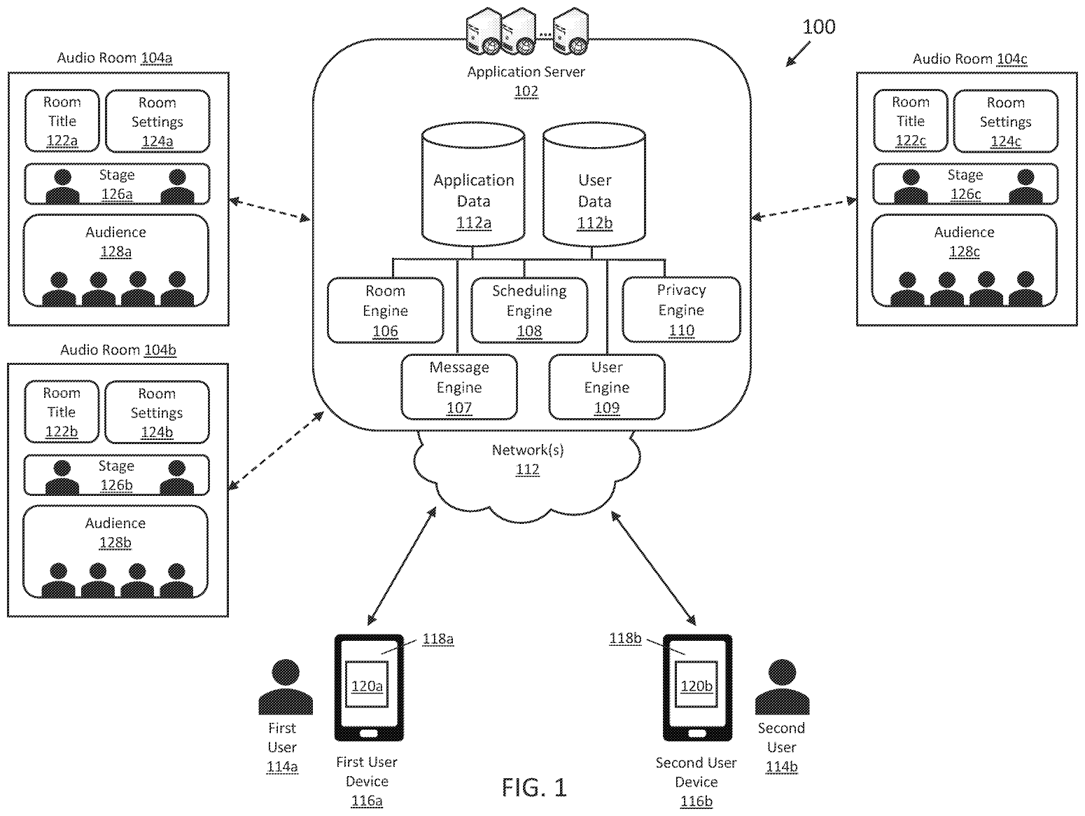

FIG. 1 is a block diagram of a system 100 for providing online audio discussion forums (i.e., rooms) in accordance with aspects described herein.

In one example, the system 100 is implemented by an application server 102. The application server 102 provides functionality for creating and providing one or more audio rooms 104. The application server 102 comprises software components and databases that can be deployed at one or more data centers (not shown) in one or more geographic locations, for example. The application server 102 software components may include a room engine 106, a message engine 107, a scheduling engine 108, a user engine 109, and a privacy engine 110. The software components can comprise subcomponents that can execute on the same or on a different individual data processing apparatus. The application server 102 databases may include an application database 112 and a user database 114. The databases can reside in one or more physical storage systems. Example features of the software components and data processing apparatus will be further described below.

The application server 102 is configured to send and receive data (including audio) to and from users' client devices through one or more data communication networks 112 such as the Internet, for example. A first user 114a can access a user interface (e.g., user interface 120a) of a client application (e.g., client application 118a) such as a web browser or a special-purpose software application executing on the user's client device (e.g., first user device 116a) to access the one or more audio rooms 104 implemented by the application server 102. Likewise, a second user 114b can access a user interface (e.g., user interface 120b) of a client application (e.g., client application 118b) executing on the user's client device (e.g., second user device 116b). In one example, the user interfaces 120a, 120b and the client applications 118a, 118b are substantially the same. In some examples, the client applications 118a, 118b may provide or display user-specific content.

Although this application will describe many functions as being performed by application server 102, in various implementations, some or all functions performed by application server 102 may be performed locally by a client application (e.g., client applications 118a, 118b). The client application can communicate with the application server 102 over the network(s) 112 using Hypertext Transfer Protocol (HTTP), another standard protocol, or a proprietary protocol, for example. A client device (e.g., user devices 116a, 116b) can be a mobile phone, a smart watch, a tablet computer, a personal computer, a game console, or an in-car media system. Other types of client devices are possible.

In various implementations, the system 100 can enable online discussion between users in virtual audio forums (e.g., audio rooms 104). As shown, each of the audio rooms 104 can include a room title 122, room settings 124, a stage 126, and an audience 128. In one example, the title 122 corresponds to a pre-determined topic or subject of the discussion within each audio room 104. The users in each audio room 104 can be grouped as speakers or audience members (i.e., listeners). As such, the stage 126 may include one or more speakers (i.e., users with speaking privileges) and the audience 128 may include one or more audience members (i.e., users without speaking privileges).

In one example, users can navigate between various audio rooms as speakers and audience members via the client application 118. For example, the first user 114a may start a new audio room (e.g., 104a) as a speaker. In some examples, when starting the audio room 104a, the first user 114a may configure the room title 122a and the room settings 124a. The first user 114a may invite the second user 114 (or any other user) to join the first audio room 104a as a speaker or as an audience member. The second user 114 may accept the invitation to join the first audio room 104a, join a different audio room (e.g., 104b), or start a new audio room (e.g., 104c).

In one example, the room engine 106 of the application server 102 is configured to generate and/or modify the audio rooms 104. For example, the room engine 106 may establish the room title 122 and the room settings 124 based on user input provided via the client application 118 and/or user preferences saved in the user database 112b. In some examples, users can transition from speaker to audience member, or vice versa, within an audio room. As such, the room engine 106 may be configured to dynamically transfer speaking privileges between users during a live audio conversation. In certain examples, the audio rooms 104 may be launched by the room engine 106 and hosted on the application server 102; however, in other examples, the audio rooms 104 may be hosted on a different server (e.g., an audio room server).

The message engine 107 is configured to provide messaging functions such that users can communicate on the platform outside of audio rooms. In one example, the message engine 107 enables text-based messaging between users. The message engine 107 may be configured to support picture, audio, and/or video messages. In some examples, the message engine 107 allows users to communicate in user-to-user chat threads and group chat threads (e.g., between three or more users).

The scheduling engine 108 is configured to enable the scheduling of future audio rooms to be generated by the room engine 106. For example, the scheduling engine 108 may establish parameters for a future audio room (e.g., room title 122, room settings 124, etc.) based on user input provided via the client application 118. In some examples, the future audio room parameters may be stored in the application database 112a until the scheduled date/time of the future audio room. In other examples, the application database 112a may store the future audio room parameters until the room is started by the user via the client application 118.

The user engine 109 is configured to manage user relationships. For example, the user engine 109 can access the user database 112b to compile lists of a user's friends (or co-follows), external contacts, etc. In some examples, the user engine 109 can monitor and determine the status of a user. The user engine 109 may determine which users are online (e.g., actively using the platform) at any given time. In certain examples, the user engine 109 is configured to monitor the state of the client application 118 on the user device 116 (e.g., active, running in the background, etc.).

The privacy engine 110 is configured to establish the privacy (or visibility) settings of the audio rooms 104. The privacy settings of each audio room 104 may be included as part of the room settings 124. In one example, the privacy settings correspond to a visibility level of the audio room. For example, each audio room may have a visibility level (e.g., open, social, closed, etc.) that determines which users can join the audio room. In some examples, the visibility level of the audio room may change based on a speaker in the audio room, behavior in the audio room, etc. As such, the privacy engine 110 can be configured to dynamically adjust the visibility level of the audio room. In certain examples, the privacy engine 110 can suggest visibility level adjustments (or recommendations) to the speaker(s) in the audio room.

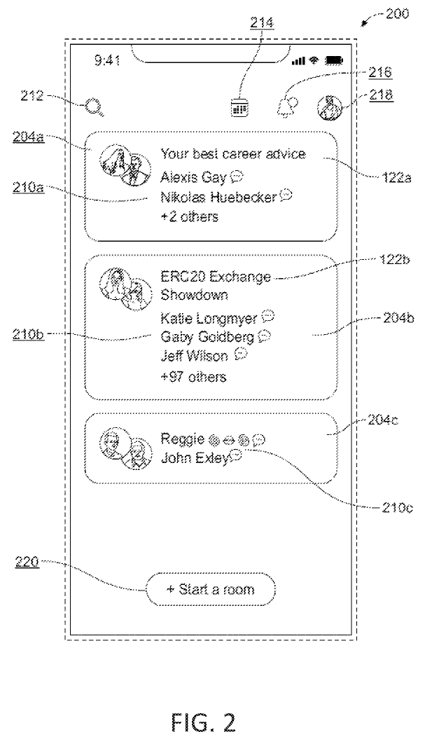

FIG. 2 is an example view 200 of the user interface 120 in accordance with aspects described herein. In one example, view 200 of the user interface 120 corresponds to a homepage of the client application 118. FIG. 2 and other figures presenting user interfaces in this application include icons and labels and refer to various features displayed by the user interface (e.g., search, schedule, notifications, etc.). While such icons and labels will be used to reference and describe such features in this application, the features may be presented with different icons and labels as well.

As shown, the user interface 120 can display live and/or upcoming audio rooms to the user. For example, home page 200 includes a first audio room tile 204a corresponding to the first audio room 104a having a title 122a named “Your best career advice,” a second audio room tile 204b corresponding to the second audio room 104b having a title 222b named “ERC20 Exchange Showdown,” and a third audio room tile 204c corresponding to the third audio room 104c. The audio rooms tiles 204 may be displayed in a scrollable list referred to as a “hallway.” In one example, the room engine 106 of the application server 102 is configured to select the audio rooms displayed to the user based on data from the application database 112a and/or the user database 112b. As shown, a list of users 210 associated with each audio room can be displayed in the audio room tiles 204 under the title of the audio room 122. In one example, the list of users 210 represents the current speakers in the audio room; however, in other examples, the list of users 210 may represent a different group of users (e.g., original speakers, all users, etc.). The user may join any of the audio rooms represented by the displayed audio room tiles 204 by selecting (e.g., tapping) on a desired audio room tile 204.

The user interface 120 may include icons representing various functions. For example, view 200 of the user interface 120 includes icons corresponding to an explore function 212, a calendar function 214, a notification function 216, a user profile function 218, and a new room function 220. In some examples, the functions are configured to be performed by various combinations of the system engine 106, the scheduling engine 108, and the privacy engine 110 of the application server 102.

In one example, the explore function 212 allows the user to search for different users and clubs. The explore function 212 may allow the user to search for other users by name (or username) and clubs by title (i.e., topic). For example, the user may use the explore function 212 to find clubs related to specific topics (e.g., finance, TV shows, etc.). Likewise, the user may use the explore function 212 to view the clubs that specific users are members of. In some examples, the explore function 212 may be performed, at least in part, by the room engine 106 of the application server 102.

The calendar function 214 is configured to display upcoming audio rooms associated with the user. In one example, the calendar function 214 may display upcoming audio rooms where the user is a speaker and/or audio rooms that the user has indicated interest in attending. For example, the calendar function 214 may display upcoming audio rooms where at least one speaker is followed by the user and audio rooms associated with clubs that the user is a member of. In some examples, the calendar function 214 is performed, at least in part, by the scheduling engine 108 of the application server 102. Likewise, the notification function 216 is configured to notify the user of user-specific notifications. For example, the notification function 216 may notify the user of an event (e.g., upcoming audio room), the status of a user follow request, etc.

In some examples, the user profile function 218 allows the user to view or update user-specific settings (e.g., privacy preferences). Likewise, the user profile function 218 allows the user to add/modify user parameters stored in the user database 112b. In some examples, the user profile function 218 may provide the user with an overview of their own social network. For example, the user profile function 218 can display other users who follow the user, and vice versa. The user profile function 218 may be performed, at least in part, by the privacy engine 110 of the application server 102.

In one example, the new room function 220 allows the user to start a new audio room. In some examples, the new room function 220 may be performed by the room engine 106 and/or the scheduling engine 108.

The system 100 of FIG. 1 and the user interface 120 of FIG. 2 are described in greater detail in U.S. patent application Ser. No. 17/875,742, filed on Jul. 28, 2022 and titled “FEATURES FOR ONLINE DISCUSSION FORUMS,” the entity of which is incorporated by reference herein.

### Houses

Social clubs (termed “Houses”) are private organizations that exist within the greater online community provided by the system 100 of FIG. 1. These Houses may be accessed and experienced by users via the client application 118, and access to the House may be restricted to those who are members of the House, or those who are guests of members. Houses make it easier for people to assemble their friends and communities and engage with them over time.

Houses provide vibrant communities that a user wants to invite their friends into.

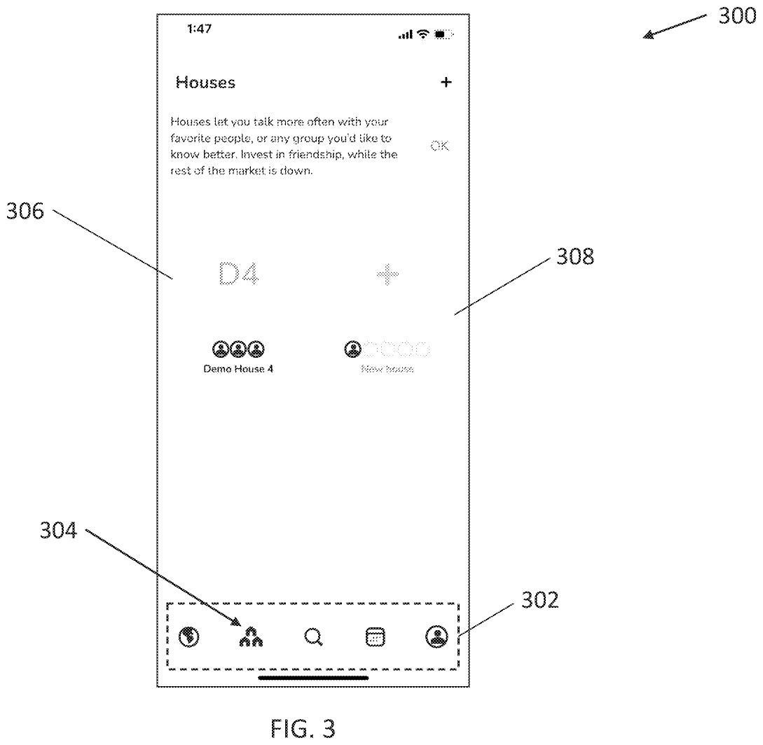

FIG. 3 is an example view 300 of the user interface 120 in accordance with aspects described herein. In one example, the view 300 corresponds to a Houses menu presented to the user (e.g., user 114). The Houses menu may be presented to the user in response to the user selecting the Houses icon 304 from a menu bar 302. As shown, the user may select an icon 306 for an existing House (e.g., “Demo House 4”) or an icon 308 to create a new House. The icon 306 (or an icon for any existing House) may include a House logo, a House name, and one or more user icons. The user icons may indicate the creator(s) of the House, the members of the House, or the active users within the House at any given time. In one example, only existing Houses that the user is a member of are shown in the Houses menu. While only a single existing House is shown, it should be appreciated that the user may be a member of two or more Houses (e.g., 3, 20, 100, etc.).

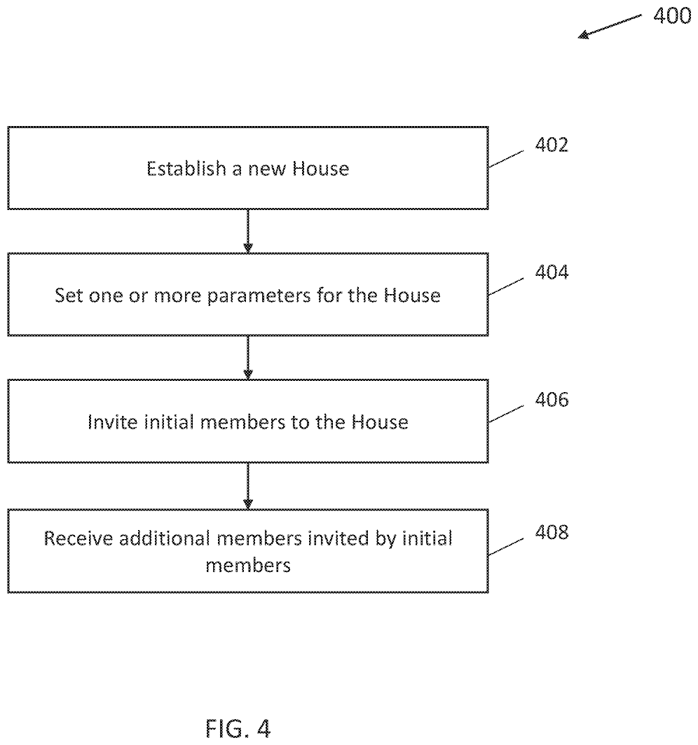

FIG. 4 is a flow diagram of a method 400 for creating a new House in accordance with aspects described herein. In one example, the method 400 is performed in response to a user (e.g., the user 114) selecting the new House icon 308 in FIG. 3. In some examples, the method 400 is carried out by the client application 118 and one or more engines of the application server 102 (e.g., the message engine 107, the user engine 109, etc.).

At block 402, the user (or creator) establishes the new House. The creator may provide a name when establishing the House (e.g., “Demo House 4”, “Basketball Fans”, “Stock Market Tips”, etc.). In one example, the creator may provide a logo for the House. In some examples, a logo may be automatically generated for the House.

At block 404, the creator sets one or more parameters for the House. Such parameters may include the number of invites provided to each member (e.g., 1, 3, 5, etc.), the assignment of other users as House administrators, and notification settings for the House. In some examples, a recurring audio room may be scheduled for House members (e.g., weekly, monthly, etc.).

At block 406, the creator invites one or more other users to become initial members of the House. The creator may invite other users who they feel will make valuable contributions to the House (e.g., based on the theme or purpose of the House). Such contributions may include content provided by the user and/or access to the user's personal network. Each user who accepts the invite may become a member of the House. The House may then be added to the Houses menu (e.g., view 300 of FIG. 3) for each member such that they can access the House via the user application 118. The initial member group may include users of the platform and/or other contacts of the House creator. In some examples, off-platform contacts may be prompted, upon acceptance of the House invite, to create a user account on the platform before joining the House. In other examples, off-platform contacts may join the House as a guest (e.g., without a user account on the platform).

At block 408, additional members invited by the initial members may join the House. As described above, each member of the House may receive a set number of invites upon joining the House. Initial members may distribute their allotment of invites to other users (e.g., on-platform or off-platform). These additional users may accept the invite to join the House. Upon joining the House, each new user receives their own allotment of invitees to distribute amongst their own personal network, and so on. The invite system of Houses is described in greater detail below.

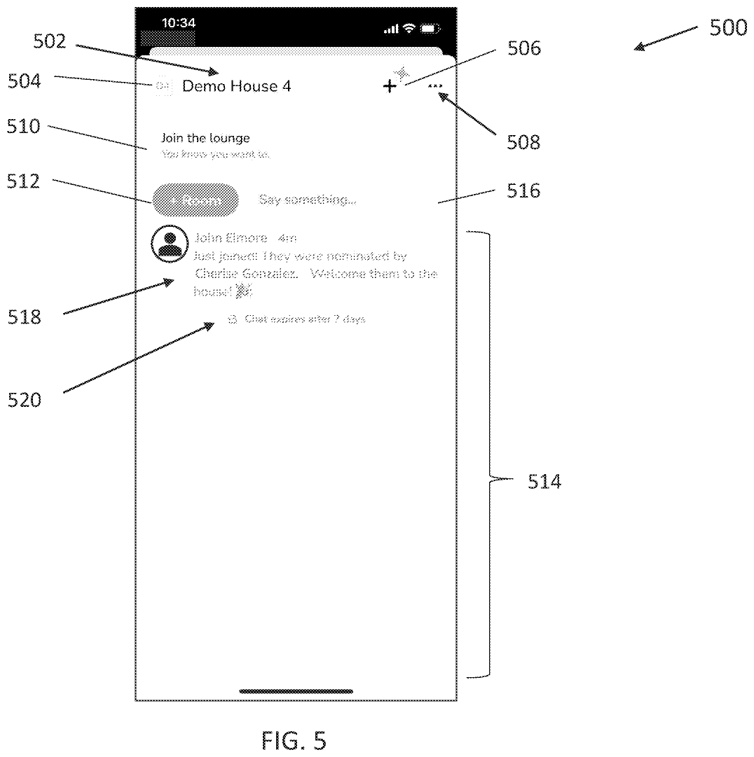

FIG. 5 is an example view 500 of the user interface 120 in accordance with aspects described herein. In one example, the view 500 corresponds to the inside of a House, as presented to a member (e.g., user 114). The view 500 may be presented to the user in response to the user selecting the icon 306 in FIG. 3 (e.g., to enter the existing House titled “Demo House 4”).

As shown, the House includes the House title 502 and the House logo 504. An invite button 506 is provided such that the user can invite others to join the House. In one example, a settings button 508 is provided. The settings button 508 may allow House creators (or admins) to adjust various settings and parameters of the House. Regular members (e.g., non-creators and non-admins) may utilize the settings button 508 to adjust various settings and parameters related to their own personal experience within the House.

In some examples, the House includes a lounge 510. The lounge 510 corresponds to a continuous audio room for House members. House members may join the lounge to converse with other active members in the House at any given time. Members may join the lounge as an active participant (e.g., microphone on) or as a passive participant (e.g., microphone off or muted). It should be appreciated that each House member may voluntarily enter or leave the lounge 510 at any time. In some examples, a member may join the lounge and remain in the lounge (e.g., as an active or passive participant) even after exiting the House (e.g., the view 500). In certain examples, each member may be automatically placed in the lounge 510 upon entering the House (e.g., at substantially the same time the view 500 is presented), and start hearing any conversations occurring in the lounge at that time.

In one example, the lounge 510 corresponds to an audio room instance that is created and remains open as long as there is at least one active (e.g., unmuted) member in the lounge. If there are no members in the lounge 510 or all members are passive (e.g., muted), the audio room instance may be closed (or terminated) until at least one member becomes active again or a new active member joins. In other words, the lounge 510 includes different audio room instances that are opened and subsequently closed based on the activity level within the lounge 510 at any given time.

The House includes a chat (or message) thread 514. In one example, the chat thread 514 is available to all members of the House. The chat thread 514 may be used to facilitate asynchronous communication amongst House members. For example, a text entry box 516 is provided such that members can enter text-based messages. In some examples, alerts or other notifications may be posted as messages in the chat thread 514. Message 518 is an example of an automated alert posted in the chat thread 514. The message 518 indicates that a new member (e.g., “John Elmore”) has joined the House and was invited (or nominated) by an existing member (e.g., “Cherise Gonzalez”). In some examples, the messages of the chat thread 514 are ephemeral. For example, as indicated by marking 520, the messages of the chat thread 514 may expire (e.g., vanish) after 7 days. It should be appreciated that the expiration may be a different period of time (e.g., 1 day, 1 month, etc.) set by the House creator(s) or admin(s). In some examples, individual members may set personal expiration dates for their own messages. For example, a first member's messages may expire after 7 days and a second member's messages may expire after only 3 days. The message expiration period may be adjustable via the settings button 508.

The view 500 may include features that indicate the presence of other members within the House or within the client application more generally. For example, while not shown, a list of members actively viewing the House or using the client application in some other way may be displayed at the top of view 500 (or any other suitable location). The list may allow the user to quickly browse other members who are active and potentially available for synchronous interactions. Likewise, active members who are in the lounge 510 may be listed or displayed in a similar manner. In some examples, a UI element (e.g., icon, button, etc.) may be displayed next to each member's profile picture, name, logo, etc. in the chat thread 514. The UI element may indicate the presence of the member such that the user is aware of the member's status when responding or interacting with the chat thread 514. In certain examples, the UI element is selectable, enabling the user to invoke a desired action (e.g., waving at the other House member). In some examples, these presence indicators could also indicate whether a user was recently viewing the House or otherwise using the client application, even if they are not doing so at that precise moment.

In some examples, notifications may be sent to House members whenever a new member joins the House. Such notifications may be dynamically sent to one or more existing House members based on various factors. For example, these factors may include connections (e.g., co-follows or contacts) between the new member and existing House members, similarities between the user profiles of the new member and existing House members, the size of the House, who is active in the House, or any other desired factors. In some examples, an audio room (e.g., a welcome room) is generated for the new member in response to at least one existing House member selecting or otherwise engaging with the notification. The welcome room may include the new member and at least a portion of the existing House members who selected or engaged with the notification.

In some examples, notifications or prompts are sent to new members to encourage them to participate in the House. Such notifications may prompt new members to introduce themselves to the House (e.g., by posting a message in the chat thread 514, starting an audio room, joining the lounge 510, etc.). The notifications or prompts may provide recommendations of other House members to interact with. For example, other House members having similar user profiles, connections, time spent in the House, etc. may be recommended to assist new members with their first interactions within the House.

In some examples, the addition of new members to the House is synchronized to enhance the welcome experience. For example, batches of new members may gain full access to the House at specific, predetermined times (e.g., recurring rooms). These recurring rooms may be scheduled periodically and can be used to control the flow of new members into the House. New members invited to join the House between the recurring rooms may be held in an outside waiting room. In one example, the outside room has limited access to the full House experience. For example, the outside room may allow new members to observe (e.g., view, listen, etc.) House activity without the ability to contribute or participate. In some examples, the outside room may include a lounge or other audio room that allows the new, pending members to chat amongst themselves while waiting for the next recurring room. Notifications or alerts may be sent to existing House members as each recurring room approaches. In certain examples, the configuration of the House is optimized for the on-boarding of new members prior to (or during) each recurring room. It should be appreciated that recurring rooms may last for any desired amount of time (e.g., 30 mins, 1 hr, 12 hrs, 1 day, etc.). By synchronizing (or gate-keeping) the welcome experience, each new member may receive a substantially consistent and repeatable transition into the House. Likewise, existing House members have notice to prepare for and coordinate the welcome experience.

In one example, new members may be prompted to complete a common task after joining a House. For example, the House creator(s) may set a question to be answered by each new member (e.g., “What's the last city you visited?”, “What experience do you have in finance?”, etc.). In some examples, each new member answer is displayed in the chat thread 514 to spark conversation. Each answer may be visible to the entire House or just a portion of the House.

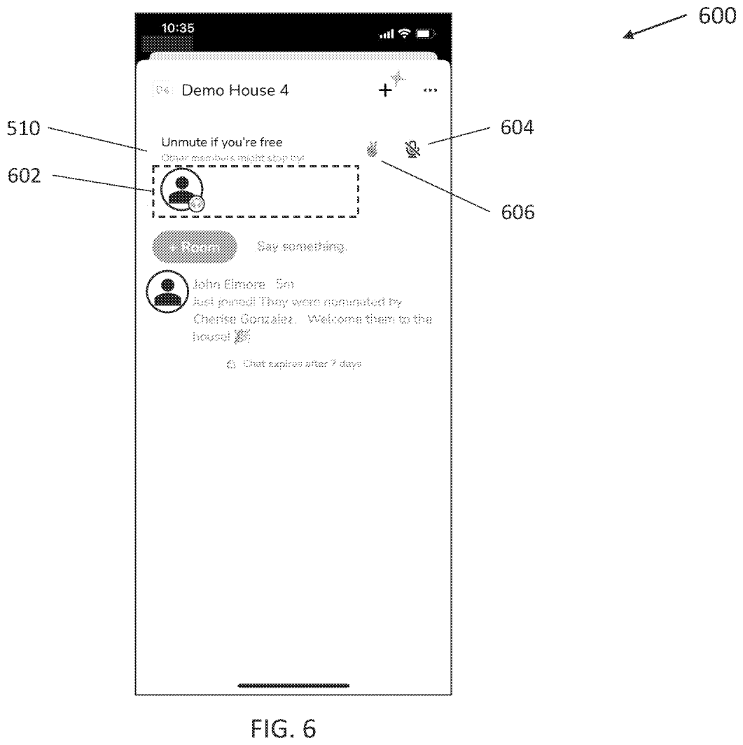

FIG. 6 is an example view 600 of the user interface 120 in accordance with aspects described herein. In one example, the view 600 is presented to a member (e.g., user 114) when they have joined the lounge 510 within the House. As shown, the lounge 510 includes a member list 602 displaying each member that is in the lounge. Each member may be represented by a member icon (e.g., profile picture, logo, initials, etc.). The member icon may include a status indicator representing the member's status within the lounge 510. For example, a status indicator showing a first symbol (e.g., headphones) may indicate that the member is a passive participant of the lounge conversation (e.g., listening only, has microphone on mute, etc.). Likewise, a status indicator showing a second symbol (e.g., a microphone) may indicate that the member is an active participant of the lounge conversation (e.g., listening and speaking, has microphone unmuted, etc.).

The lounge 510 includes a mute button 604 that enables each member to mute and unmute their microphone to switch between passive participant status and active participant status. In addition, an exit button 606 allows each member to leave the lounge 510 at any desired time. It should be appreciated that each member may remain in the lounge 510 (e.g., as a passive or active participant) even after exiting the House. For example, a House member may continue to participate in the lounge conversation while viewing a different section of the client application 118 (e.g., view 200 of FIG. 2). The House member may remain in the lounge 510 until (i) selecting the exit button 606 or (ii) initiating an action that automatically removes the House member from the lounge 510. Such actions may include joining an audio room (e.g., within the House or outside the House), closing the client application 118, receiving a phone call, etc.

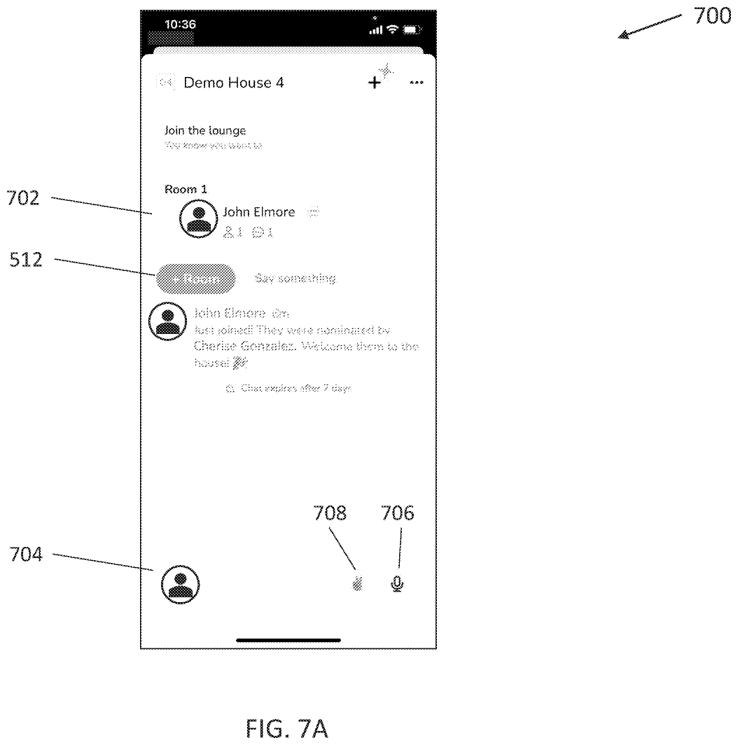

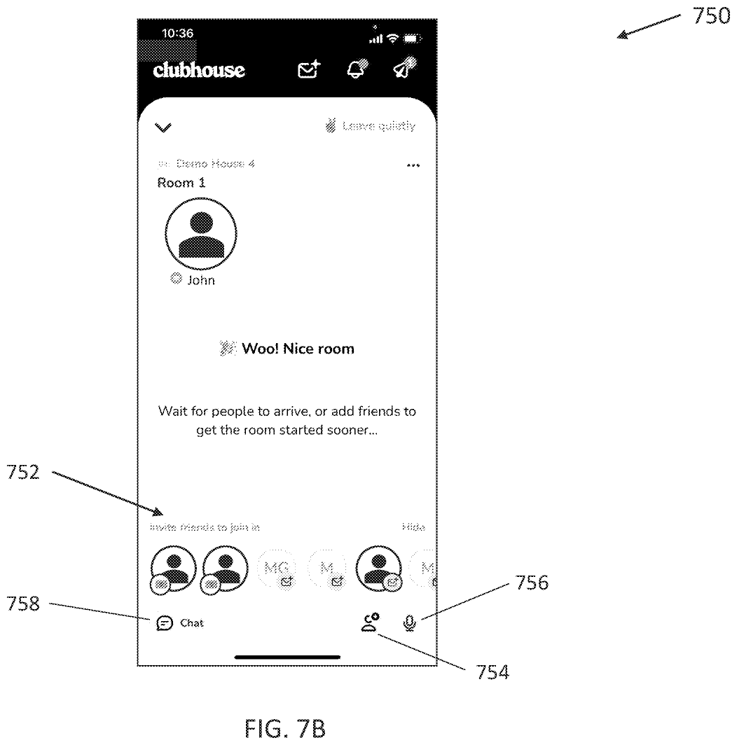

FIG. 7A is an example view 700 of the user interface 120 in accordance with aspects described herein. The view 700 represents the inside of the House when an audio room 702 is active. The audio room 702 is created by one or more House members (e.g., John Elmore in the illustrated example). In one example, the audio room 702 is open to all House members to join as speakers or listeners. In some examples, the audio room 702 may only be visible to specific House members (e.g., determined by the audio room creator(s)). In other examples, the audio room 702 may be visible to all House members, but only certain members may join as speakers. As shown, the audio room 702 is displayed to each House member with the room name (e.g., “Room 1”), a listing of the speaker(s) (e.g., John Elmore), and the number of active participants and speakers in the audio room. In some examples, each House member may join the audio room 702 by selecting (or tapping) on the audio room icon. Once joined, a room bar 704 may be presented to the House member. The room bar 704 includes a mute/unmute button 706 and an exit button 708.

FIG. 7B is an example view 750 from within the audio room 702 of FIG. 7A. In one example, the view 750 corresponds to the view presented to a creator of the audio room 702 (e.g., John Elmore). The room creator may select one or more users from an invite bar 752 to invite to the audio room 702. For example, the room creator may invite any number of House members to join the audio room 702. In some examples, the room creator may invite non-members to join the audio room 702, either by extending a “guest pass” that would allow a non-house member to join a particular room or set of rooms, or by extending an invitation to the non-member to become a member of the house. For example, user icons shown in the invite bar 752 with a “ticket” symbol represent friends (or co-follows) of the room creator who are not members of the House. The room creator may, if the room or House settings allow for it, give the non-member a “guest pass” that will allow the non-member to participate in the room without becoming a member. Guests in a room may be denoted by a special icon in their profile, and may have to create a user account on the platform before they are allowed to join. Alternatively, the room creator may invite these non-members by extending a House invite to each non-member. As described above, each House member may have an allotment of House invites (e.g., 3, 5, etc.) that they are free to distribute amongst their own personal network. Upon acceptance of the invite, each user becomes a member of the House and is added to the audio room 702. Similarly, the room creator may invite contacts who are not on the platform to join the audio room 702. For example, user icons shown in the invite bar 752 with a “mail” symbol represent contacts of the room creator who do not have user accounts on the platform. Again, the room creator may invite these non-members by extending a House invite to each non-member (e.g., up to their allotted number of invites). Upon acceptance of the invite, each contact may be prompted to create a user account before being added to the audio room 702 and becoming a member of the House. Other audio room participants may be able to invite other members or non-members to the audio room in the same manner as well if the settings of the House and the room allow for it.

In one example, the invite bar 752 displays a limited number of users. For example, the invite bar 752 may display a specific number (e.g., 10, 20, etc.) of recommended users to invite, with such recommended users ranked according to one or more algorithms. The recommended users may be ranked or arranged based on a scoring criteria. For example, a unique score may be generated for each friend (or co-follower) of the user 114. The score may provide an indication (e.g., strength, compatibility, etc.) of the relationship between the user 114 and each friend. In one example, the score is based on parameters associated with actions between the user 114 and the friend. For example, these parameters may include: the number of common rooms joined by the user 114 and the friend, the number of rooms joined by the user 114 or the friend that were hosted by the user 114 or the friend, the number of overlapping contacts (or friends) between the user 114 and the friend, room invites sent by the user 114 to the friend (or vice versa), room invites accepted by the user 114 from the friend (or vice versa), rooms shared by the user 114 that are associated with the friend (e.g., hosted by the friend), rooms shared by the friend that are associated with the user 114 (e.g., hosted by the user 114), common clubs joined by both the user 114 and the friend, a quantity or frequency of direct messages (DMs) sent between the user 114 and the friend, a number of waves sent by the user 114 to the friend, a number of waves sent by the friend to the user 114, a number of waves accepted by the user 114 from the friend, and a number of waves accepted by the friend from the user 114.

In some examples, the invite bar 752 prioritizes House members before displaying non-members and off-platform contacts. In some examples, the room creator may select a directory button 754 to access a full list of users/contacts to invite (or ping) into the audio room 702. The room creator (or other audio room participants) may utilize the mute/unmute button 756 to switch between speaker and listener during the audio room conversation. In addition, audio room participants may select a chat button 758 to access a chat thread for the audio room 702.

In one example, each House member participating in the audio room 702 is prompted to share their mutual contacts with the other participants. In such cases, each user may decide to opt-in or opt-out. If two users speaking to one another have both opted-in, then the mutual contacts (e.g., on-platform and/or off-platform) between the users may be presented to both users. As such, users may be encouraged to speak with each other to discover (or reveal) any existing mutual contacts and invite them to join the room or the House. If only one user has opted-in, or if neither user has opted-in, no mutual contacts will be visible. While the example above describes a conversation between two users, it should be appreciated that the mutual contact technique can be scaled to a conversation including any number of users. For example, if three users are conversing, and all three have opted-in, then mutual contacts will be displayed for all three users. Likewise, suppose three users are conversing but only two users have opted-in. In such an example, mutual contacts between the two users who have opted-in will be displayed only to those two users and no mutual contacts will be made visible to the user who opted-out.

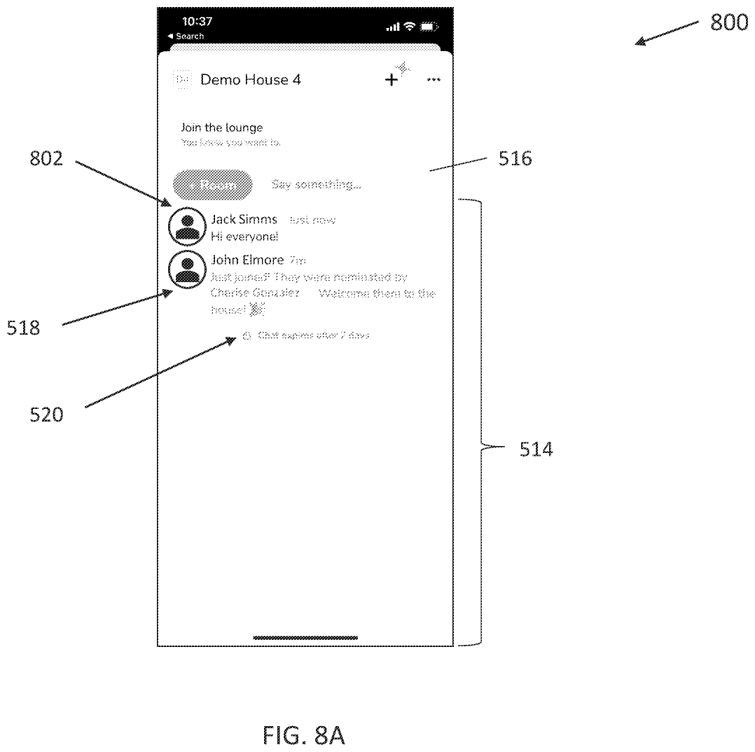

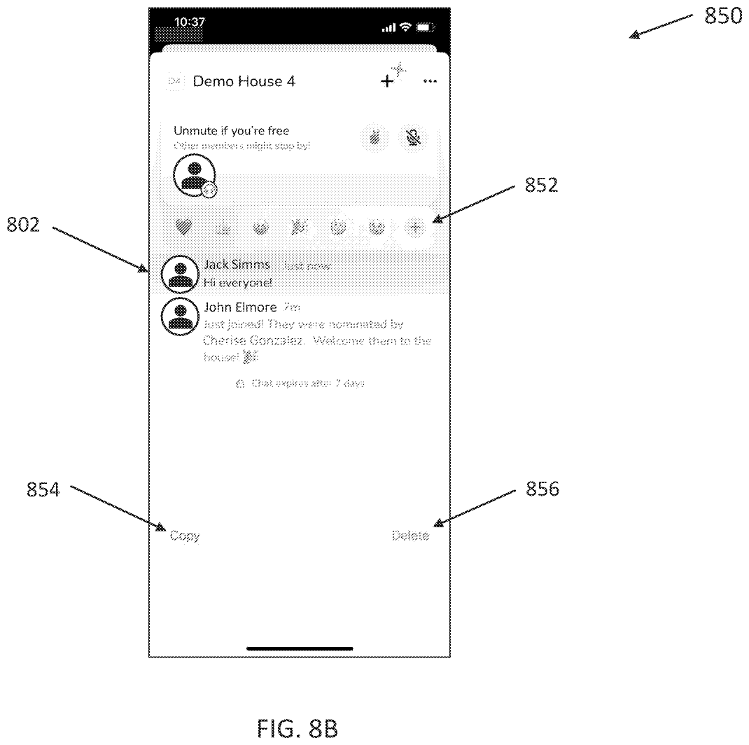

As described above, House members may communicate synchronously within the lounge 510 and audio rooms started within the House (e.g., audio room 702). However, it may be useful for House members to communicate in an asynchronous manner. FIG. 8A is an example view 800 from within the House. As shown, House members may communicate by sending asynchronous messages in the chat thread 514. The message 518 is an example of an automated alert posted in the chat thread 514. The message 802 is an example of a user generated message. Each house member may generate messages using the text entry box 516. The text messages may include “@ mentions” to inform (and notify) members that a message is directed to them. The marking 520 provides an indication of the expiration date of the messages (e.g., messages 518, 802). In some examples, the messages may never expire. It should be appreciated that the messages (e.g., user generated or automated) may include content other than text. For example, the chat thread 514 may support images, videos, GIFs, hyperlinks, audio clips, or any other desired content format.

In one example, the messages are displayed in chronological order. In other words, all messages are displayed in that chat thread 514 in the order that they are submitted. In some examples, the messages are displayed with a threaded format. In the threaded format, users may respond to existing messages. The responses are arranged below the original message to provide an organized message structure. In other examples, the messages are displayed with a ranked format. For example, messages are ranked (e.g., based on importance) and the highest ranked messages are displayed at the top of the chat thread. The rank of the message may be determined based on the source of the message, the member(s) associated with the message, and/or the content of the message. In some examples, the rank may be user specific (e.g., messages from a member's co-follows may be ranked higher). In one example, the message format for the chat thread 514 can be configured by the House creator(s) or admins. In other examples, the message format may be automatically set.

In some examples, the House members may interact with the messages in the chat thread asynchronously. FIG. 8B is an example view 850 from within the House. As shown, each House member may select (e.g., press and hold) messages to bring up an interaction menu 852. The House member may select one or more icons, symbols, or emojis to interact with (or react to) a message. In one example, the interaction is displayed for all House members to view. In certain examples, interactions with messages may contribute to the rank of the message. In some examples, the message creator (e.g., Jack Simms) may be notified when another member interacts with their message. Selecting a message may also enable the message to be copied (e.g., via copy button 854) or to be deleted (e.g., via delete button 856). In some examples, a message may only be deleted by the message creator or by an admin of the House.

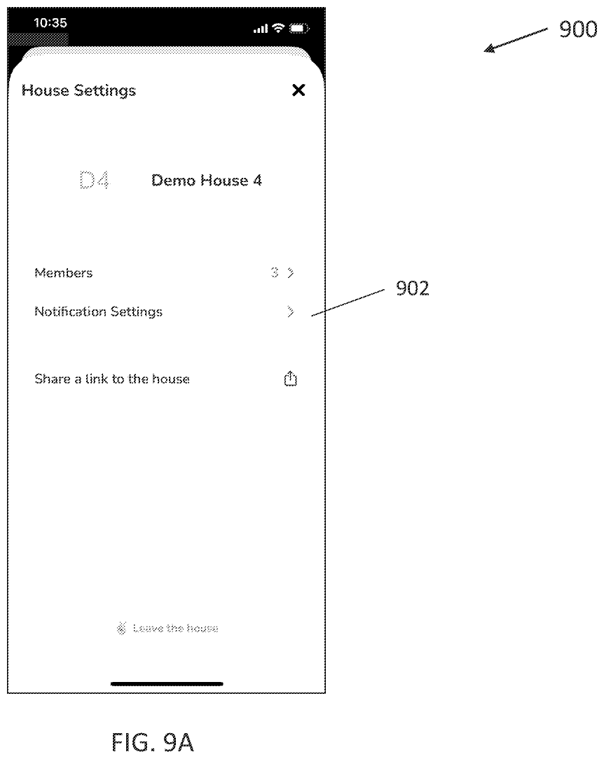

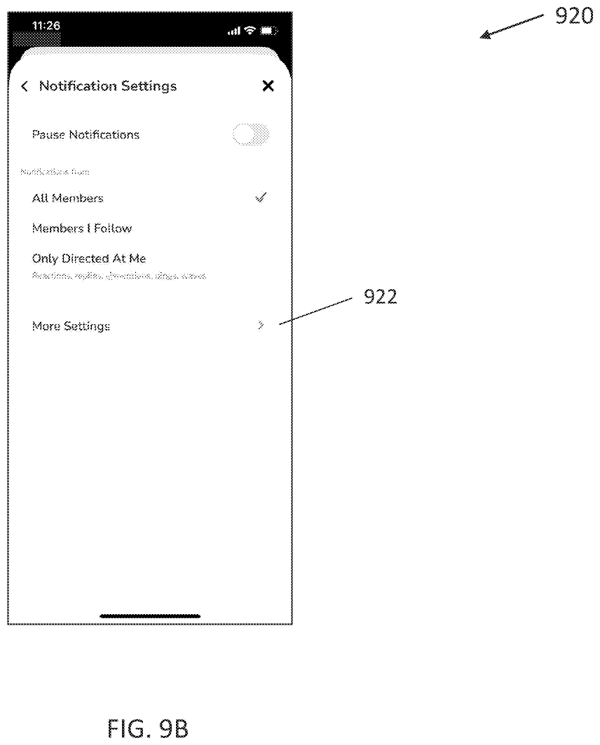

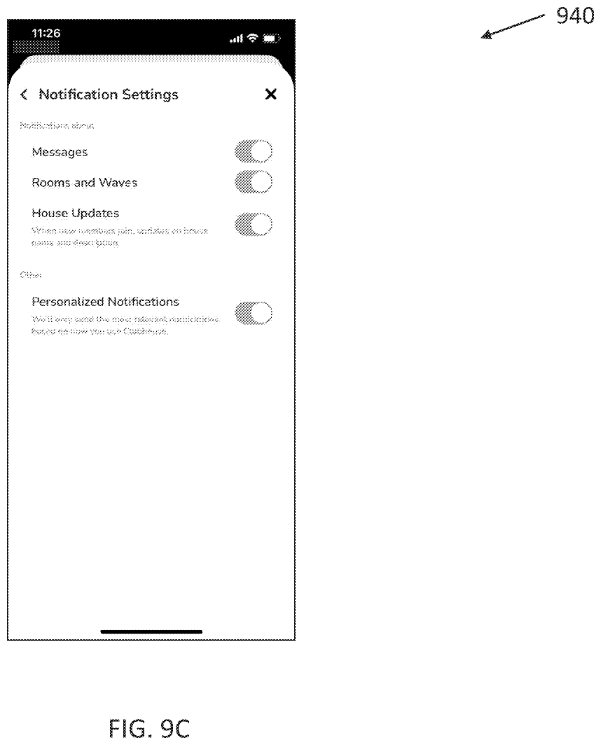

FIGS. 9A-9C illustrate various examples of settings that can be applied or adjusted for the House. In one example, the view 900 in FIG. 9A is presented in response to a House member selecting the setting button 508 in FIG. 5. Likewise, the view 920 in FIG. 9B may be presented in response to the House member selecting the notification settings button 902 in FIG. 9A. In some examples, House members, including those who have disabled notifications across the platform, may be prompted to enable, configure, re-enable, or re-configure notification preferences for their own personal experience in the House. The view 940 in FIG. 9C may be presented in response to the House member selecting the “more settings” button 922 in FIG. 9B. It should be appreciated that some of the settings shown in FIGS. 9A-9C may only be presented to (or configurable by) a House creator or House admin.

In one example, the House settings include a moderation scheme applied to the House. For example, the House may have a manual moderation scheme that enables the House admins to review flagged messages (or activity). In such cases, the admins may delete or edit the flagged content. In some examples, the admins may have the ability to suspend or ban users from the House (e.g., by suspending or revoking House membership). Flagged content may be pushed up to higher-level admins (e.g., platform admins) for review. Who the appropriate reviewer of a flagged message is could be selected based on factors such as the category or nature of the report, the timing of the report, and the channel through which the report was made. In some examples, automatic moderation schemes may be used. For example, user reports, heuristic techniques, artificial intelligence (AI) models and/or machine learning (ML) models may be used to identify and/or remove spam or offensive content. Such content may include text, images, links, or audio content used with the House. In certain examples, members can be automatically suspended for content posted based on a number of factors, including whether the content was flagged by a predetermined amount of members (e.g., 5% or more), the category of the flag, the history of the member, or the status of the reporting user. Automatic suspensions can later be reviewed by an admin to confirm or remove the violation, and for further action such as reinstating the member or permanently banning the member.

It should be appreciated that audio rooms within a House may support auxiliary audio content (e.g., other than live user speech content). For example, House audio rooms (including the lounge 510) may provide a soundboard functionality that enables users to engage or react with different types of auxiliary audio content. Such auxiliary audio content can include audio clips, recordings, music, noises, exclamations, etc.

### House Invites

As described above, the House creator(s) may invite one or more other users to become initial members of the House. The creator may invite other users who they feel will make valuable contributions to the House (e.g., based on the theme or purpose of the House). The initial members may then invite additional members to join the House. Each member of the House may receive a set number of invites upon joining the House to distribute amongst their personal network.

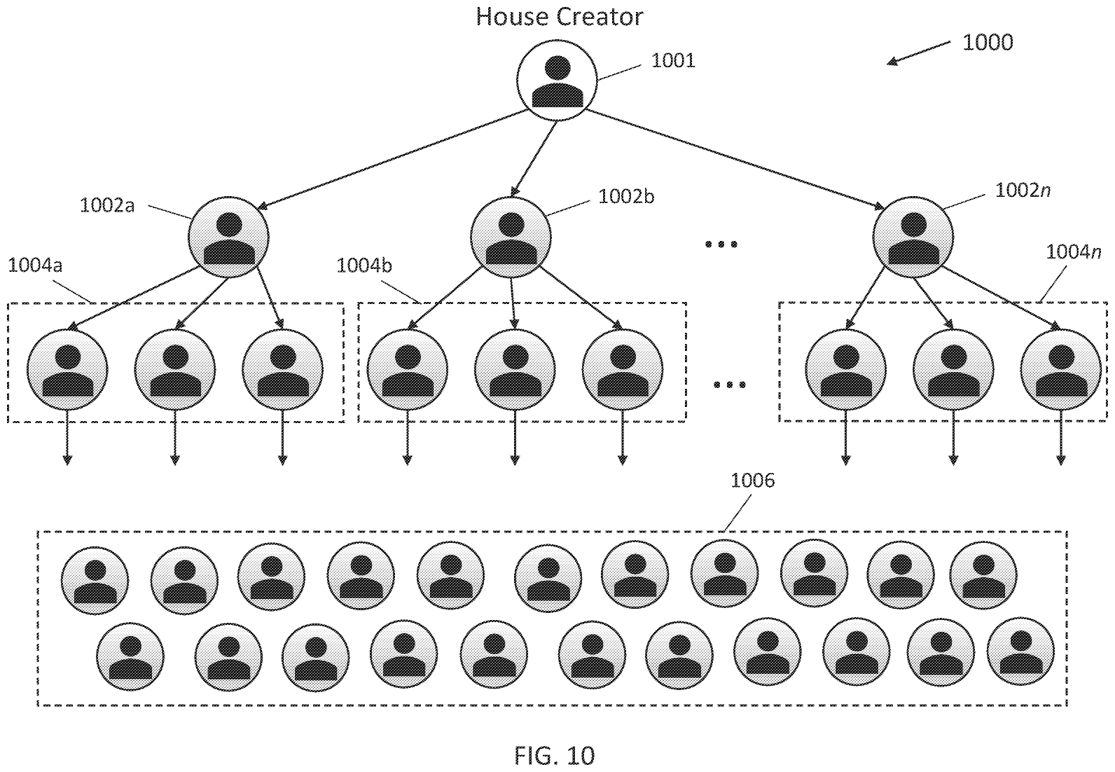

FIG. 10 is a diagram 1000 illustrating an example invite system in accordance with aspects described herein. In one example, a House creator 1001 provides House invites to a plurality of initial members 1002. In some examples, the House creator 1001 has an unlimited number of invites to distribute at any given time; however, in other examples, the number of invites held by the House creator 1001 may be limited (e.g., due to platform restrictions, spam mitigation, etc.).

Upon joining the House, the initial members may receive an allotment of invites to distribute (e.g., 3, 5, 7, etc.). The number of invites provided to each initial member 1002 (or any non-creator member) may be set by the House creator 1001. Each initial member may distribute their allotted invites to other users of the platform or off-platform contacts. For example, a first initial member 1002a may distribute invites to a first group of additional users 1004a, the second initial member 1002b may distribute invites to a second group of additional users 1004b. Any off-platform contacts that receive invites may be prompted, upon acceptance of the House invite, to create a user account on the platform before joining the House. Upon joining the House, the additional users 1004 may receive their own allotment of invites to distribute, and so on.

The invite “tree” may continue to expand over time to develop a cohort of House members 1006. In some examples, each new member receives the same allotment of invites. For example, the initial members 1002 may receive the same number of invites as the additional members 1004. In other examples, the number of invites provided to each new member may be determined algorithmically based on a number of factors. For example, earlier members (e.g., the initial members 1002) may be given more invites than later members (e.g., the additional members 1004), and so on. As such, greater influence in developing the cohort 1006 may be given to the members who are “closer” to the House creator 1001. In some examples, the minimum number of invites allotted to a new user may be one. In other examples, new members arriving after a specific threshold (e.g., 100 members, 500 members, 1000 members, etc.) may be given no invites. In certain examples, the number of invites provided to new members corresponds to the member's relationship or connection to the cohort 1006. For example, members that co-follow a greater number of connections to the existing cohort 1006 may be given more invites than new members having minimal connections to the existing cohort 1006. Or members who are invited by very active or high quality members may be given more invites.

The House creator 1001 may accelerate the growth of the House (e.g., the size of the cohort 1006) by providing supplemental invites to existing members. In one example, the House creator 1001 periodically distributes additional invites to all or a sub-set of House members. In some examples, House members may be automatically awarded additional invites based on their activities. For example, House members may be awarded invites for contributing to activity in the House (e.g., starting audio rooms, engaging in chat threads, attending recurring audio rooms, etc.). Likewise, House members may be awarded invites based on the success of their previous invites. For example, a member may be awarded invites based on the recognition that their previous invitees are contributing to activity in the House. A member may be awarded invites if they or their invitees are building strong connections with other cohort members (e.g., adding each other as co-follows).

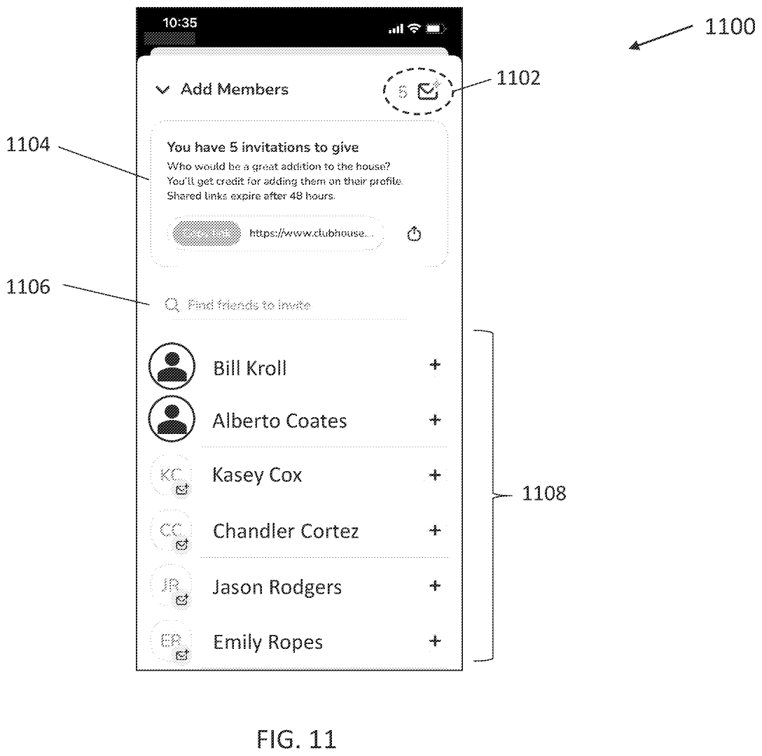

FIG. 11 is an example view 1100 of the user interface 120 in accordance with aspects described herein. In one example, the view 1100 is presented in response to a House member selecting the invite button 506 of FIG. 5. In one example, the view 1100 includes an invite counter 1102, an invite link 1104, a search box 1106, and a recommended user list 1108.

The invite counter 1102 indicates the number of House invites that the member has to distribute. As described above, each member may receive an allotment of invites upon joining the House. In some examples, additional invites may be provided to the member over time. In one example, the invite link 1104 can be used to invite other users (or contacts) to join the House. The member may share the link with other users (or contacts), who may click on the link to join the House. The link 1104 may allow a specific number of users to join the House. For example, the number of users allowed to join the House may correspond to the number of invites allotted to the corresponding member at any given time (e.g., 3, 5, 7, etc.). Once the invite allotment is reached, the link may cease to provide (or allow) entry to the House. In some examples, the link 1104 may have a temporal existence. For example, the link 1104 may cease to provide (or allow) entry to the House after a predetermined time (e.g., 24 hrs, 48 hrs, etc.) has expired after the creation of the link. The link 1104 is associated with the member, and the member will get credit for each new member who joins the House via the link 1104.

Rather than sharing the link 1104, House members may search for other users (or contacts) using the search box 1106. House members may also browse the recommended user list 1108 when determining who to invite. In some examples, the users included in the list 1108 correspond to friends (or co-follows) of the user. The users may be ranked based on the strength of the relationship between the House member and each user. In other examples, the users may be ranked based on a perceived compatibility with the House. For example, users who have existing relationships with other existing House members may be ranked higher. In some examples, users having a background that aligns with the subject matter, purpose, or theme of the House may be ranked higher.

In some examples, users (e.g., non-members) may request to join a waitlist associated with a House. For example, House members may view the waitlist and extend invites to non-members who have joined the waitlist. In other examples, a predetermined number of users (e.g., 1, 10, 100, etc.) may be admitted to the House at a periodic interval (e.g., once a day, once a week, etc.). For example, the next 10 users from the waitlist may be admitted to the House every Monday. In some examples, House members may receive a notification whenever one of their friends (or co-followers) joins the waitlist.

Each House that a user is a member of may be displayed on the user's profile page. As such, other users may view the House(s) that a particular user is a member of. In some examples, users may select a House from the profile page of another user to join the waitlist associated with the selected House. In one example, users may receive notifications when one of their friends (or co-followers) joins a new House. Users may select the notification to join the waitlist associated with the corresponding House.

### Dynamic Scaling

As described above, the House creator may set one or more initial parameters for the House. Such parameters may include the number of invites provided to each member, the assignment of other users as House administrators, and notification settings for the House. These parameters may also include the configuration of the lounge 510, the format of the chat thread 514, the types of moderation used in the House, and various other parameters or settings. In one example, the initial parameters may remain in place for the life of the House. The parameters may be scaled based on any number of factors, including the size of the House (e.g., the number of members), the volume of activity within the House, the types of activity most common within the House, or the frequency of engagement in the House.

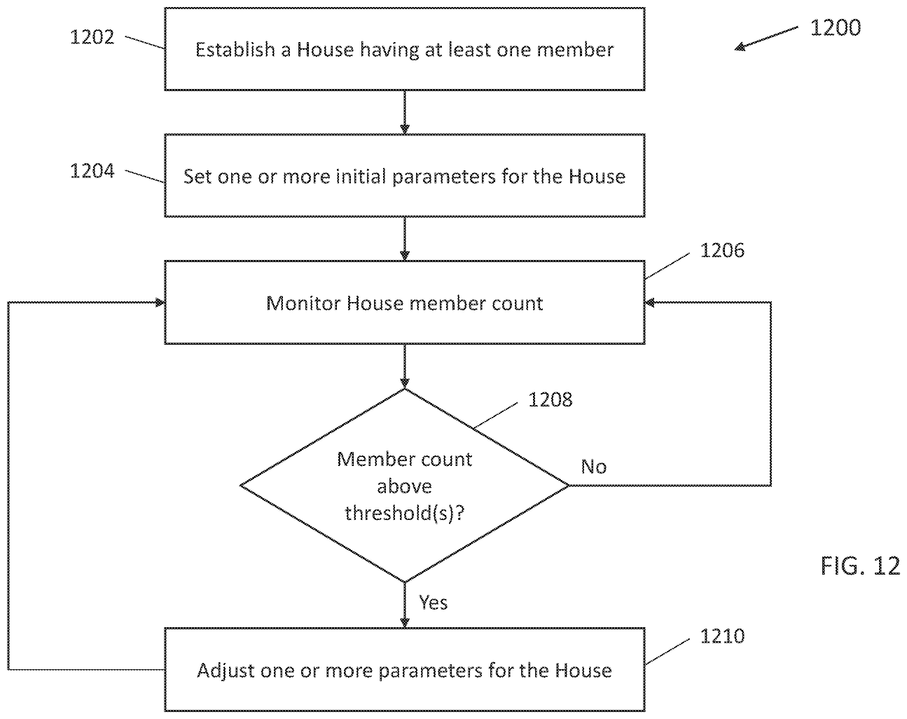

FIG. 12 illustrates a flow diagram of a method 1200 for dynamically scaling a House in accordance with aspects described herein. In one example, the method 1200 is carried out by the client application 118 and one or more engines of the application server 102 (e.g., the message engine 107, the user engine 109, etc.).

At block 1202, the House is established with at least one member. In one example, the House is established as described in block 402 of the method 400 of FIG. 4. The at least one member may include the House creator(s) and any initial members invited by the creator(s).

At block 1204, one or more initial parameters are set for the House. In one example, the parameters are set as described in block 404 of the method 400 of FIG. 4. Such initial parameters may include the number of invites provided to each member, the number of House administrators, notification settings, the configuration of the lounge 510, the format of the chat thread 514, the types of moderation used in the House, and various other parameters or settings.

At block 1206, the House member count is monitored. In one example, the House member count is monitored periodically (e.g., every 12 hrs, once a day, once a week, etc.). As described above, the House member count is expected to increase over time as members invite new members.

At block 1208, the House member count is compared to at least one threshold. For example, the House member count may be compared to a single threshold (e.g., 500 members). In some examples, the House member count is compared to a first threshold (e.g., 100 members), a second threshold (e.g., 500 members), a third threshold (e.g., 1000 members), and so on. It should be appreciated that any number of thresholds and/or threshold levels may be used. In some examples, the number of thresholds (or the threshold levels) may be configured by the House creator(s) or admins.

At block 1210, one or more parameters of the House are adjusted based on a determination that House member count is above at least one threshold. For example, the number of invites provided to each member may be increased or decreased. In some examples, the number of invites provided to new members may be decreased as the House grows in size. The number of House administrators may be increased based on the size of the House (e.g., from 2 to 4). Likewise, notification settings may be adjusted to manage the volume of notifications. For example, when the House size is relatively small, notifications may be unfiltered (e.g., all members receive all notifications). However, when the House size becomes relatively large, notifications may be filtered (e.g., members only receive notifications relevant to them). In some examples, the lounge 510 may be split into multiple lounges or capped at a certain number of participants. In one example, the format of the chat thread 514 may be switched between chronological, threaded, or ranked messages based on the House size. In some examples, the moderation scheme applied to the House may be switched between manual to automatic based on the size of the House.

Table 1 represents several parameter adjustments that may be made once the House member count exceeds a single threshold (e.g., 500 members). Likewise, Table 2 represents several parameter adjustments that may be made once the House member count exceeds different thresholds (e.g., 100 members, 500 members, and 1000 members).

TABLE 1

| Parameter | Initial | Above Threshold |
|---|---|---|
| Chat Message Format | Chronological | Ranked |
| Number of Admins | 2 | 4 |
| Moderation | Manual | Automatic |
| Notifications | Unfiltered | Filtered |
| Number of Invites | 5 | 2 |

TABLE 2

| | | Above 1^{st} | Above 2^{nd} | Above 3^{rd} |
|---|---|---|---|---|
| Parameter | Initial | Threshold | Threshold | Threshold |
| Chat Message | Chronological | Threaded | Threaded | Ranked |
| Format | | | | |
| Number of | 2 | 4 | 6 | 8 |
| Admins | | | | |
| Moderation | Manual | Automatic | Automatic | Automatic |
| Notifications | Unfiltered | Unfiltered | Filtered | Filtered |
| Number of Invites | 5 | 5 | 2 | 1 |

After the one or more parameters of the House are adjusted, the method returns to block 1206 and continues to monitor the House member count.

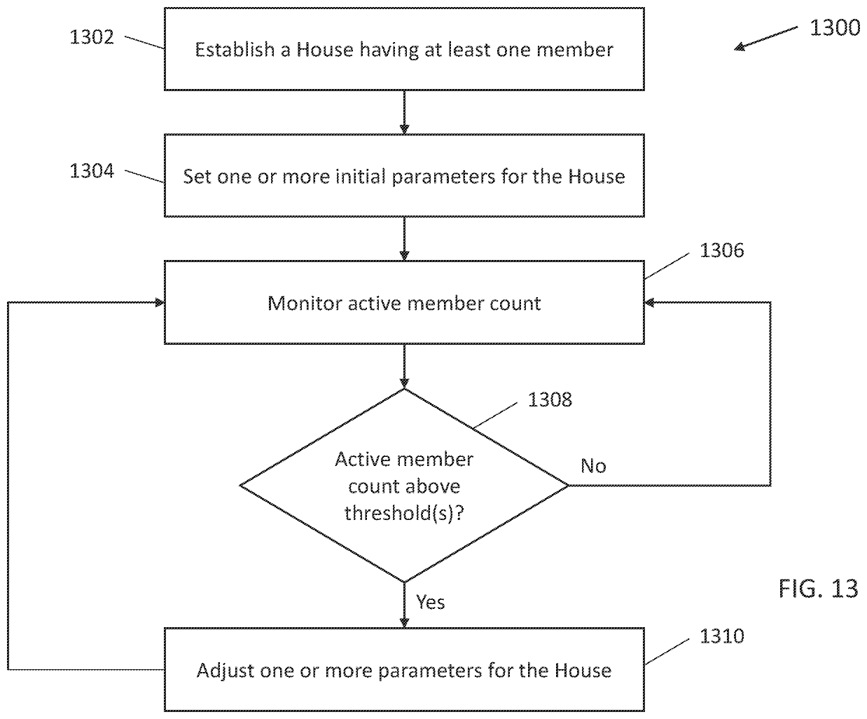

FIG. 13 illustrates a flow diagram of a method 1300 for dynamically scaling a House in accordance with aspects described herein. Rather than scaling the House configuration based on the House member count, the method 1300 relies on the active member count within the House. In one example, the method 1300 is carried out by the client application 118 and one or more engines of the application server 102 (e.g., the message engine 107, the user engine 109, etc.).

At block 1302, the House is established with at least one member. In one example, the House is established as described in block 402 of the method 400 of FIG. 4. The at least one member may include the House creator(s) and any initial members invited by the creator(s).

At block 1304, one or more initial parameters are set for the House. In one example, the parameters are set as described in block 404 of the method 400 of FIG. 4. Such initial parameters may include the number of invites provided to each member, the number of House administrators, notification settings, the configuration of the lounge 510, the format of the chat thread 514, the types of moderation used in the House, and various other parameters or settings.

At block 1306, the active member count is monitored. In one example, the active member counts represents the number of members in the House at any given time. For example, if there are 1000 House members and 200 are actively within the House (e.g., using the House features, speaking with House members, listening to House conversations, etc.) then the active member count is 200. In some examples, House members who are in the lounge 510 but have navigated away from the House may be included in the active member count.

At block 1308, the active member count is compared to at least one threshold. For example, the active member count may be compared to a single threshold (e.g., 50 members). In some examples, the House member count is compared to a first threshold (e.g., 10 members), a second threshold (e.g., 50 members), a third threshold (e.g., 100 members), and so on. It should be appreciated that any number of thresholds and/or threshold levels may be used. In some examples, the number of thresholds (or the threshold levels) may be configured by the House creator(s) or admins.

At block 1310, one or more parameters of the House are adjusted based on a determination that active member count is above at least one threshold. For example, the configuration of the House may be adjusted similar to the examples described above in block 1210 of the method 1200 of FIG. 12. After the one or more parameters of the House are adjusted, the method returns to block 1306 and continues to monitor the active member count.

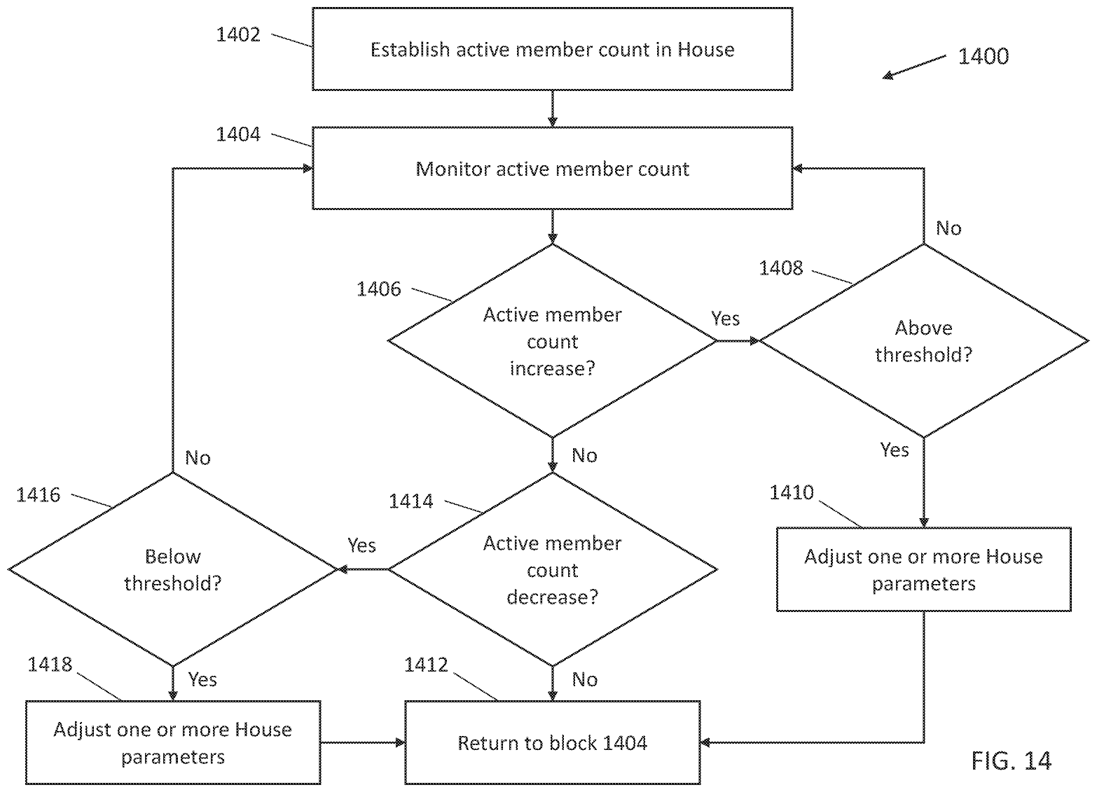

FIG. 14 illustrates a flow diagram of a method 1400 for dynamically scaling a House in accordance with aspects described herein. Rather than only scaling up the House configuration based on the active member count, the method 1400 scales the House configuration up and down based on the active member count. In one example, the method 1400 is carried out by the client application 118 and one or more engines of the application server 102 (e.g., the message engine 107, the user engine 109, etc.).

At block 1402, an initial active member count is established. In one example, the active member counts represents the number of members in the House at any given time.

At block 1404, the active member count is monitored. The active member count is monitored relative to at least one threshold. For example, the active member count may be compared to a single threshold (e.g., 50 members). In some examples, the House member count is compared to a first threshold (e.g., 10 members), a second threshold (e.g., 50 members), a third threshold (e.g., 100 members), and so on. It should be appreciated that any number of thresholds and/or threshold levels may be used. In some examples, the number of thresholds (or the threshold levels) may be configured by the House creator(s) or admins.

At block 1406, it is determined whether the active member count has increased. In response to a determination that the active member count has increased, the method 1400 continues to block 1408.

At block 1408, based on an increase in the active member count, it is determined whether the active member count has exceeded one or more of the thresholds. In response to a determination that the active member count has risen above one or more thresholds, the method proceeds to block 1410. In response to a determination that the active member count has not risen above one or more thresholds (e.g., has not increased by enough to trigger action), the method returns to block 1404.

At block 1410, one or more parameters of the House are adjusted based on a determination that active member count has exceeded at least one threshold. For example, the configuration of the House may be adjusted similar to the examples described above in block 1210 of the method 1200 of FIG. 12 or block 1310 of the method 1300 of FIG. 13. In examples having multiple thresholds (e.g., Table 2), the adjustments may correspond to the specific threshold crossed. For example, the adjustments for rising above a first threshold (e.g., 10 members) may be different from those made for rising above a second threshold (e.g., 50 members) or a third threshold (e.g., 100 members). After the one or more parameters of the House are adjusted, the method continues to block 1412 (and returns to block 1404). Returning to block 1406, in response to a determination that the active member count has not increased, the method 1400 proceeds to block 1414. At block 1414, it is determined whether the active member count has decreased. In response to a determination that the active member count has decreased, the method 1400 continues to block 1416.

At block 1416, based on a decrease in the active member count, it is determined whether the active member count has fallen below one or more of the thresholds. In response to a determination that the active member count has fallen below one or more thresholds, the method proceeds to block 1418. In response to a determination that the active member count has not fallen below one or more thresholds (e.g., has not decreased by enough to trigger action), the method returns to block 1404.

At block 1418, one or more parameters of the House are adjusted based on a determination that active member count has fallen below at least one threshold. In examples having multiple thresholds (e.g., Table 2), the adjustments may correspond to the specific threshold crossed. For example, the adjustments for falling below a third threshold (e.g., 100 members) may be different from those made for falling below a second threshold (e.g., 50 members) or a first threshold (e.g., 10 members). After the one or more parameters of the House are adjusted, the method continues to block 1412 (and returns to block 1404).

In other examples, parameters of the House may be scaled based on other factors. For example, the message format of the chat thread 514 may be scaled based on message volume. In high volume cases, the messages may be presented with a ranked format. Likewise, in low-volume cases, the messages may be presented with a chronological format.

### Hardware and Software Implementations

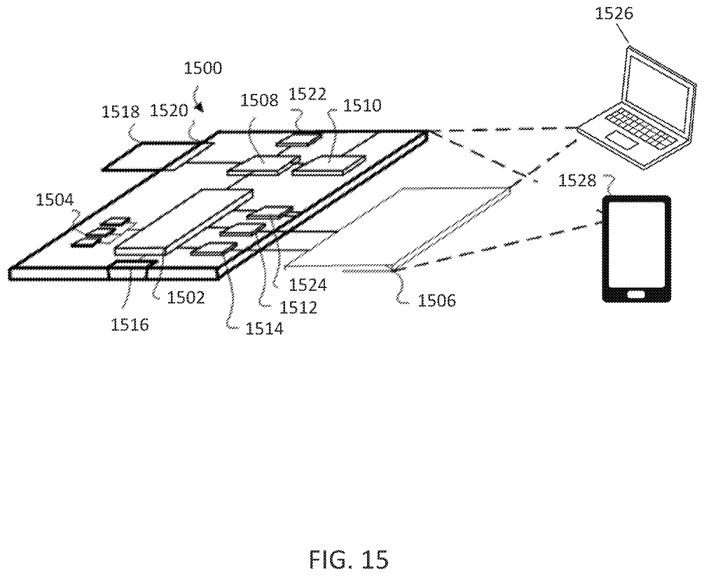

FIG. 15 shows an example of a generic computing device 1500, which may be used with some of the techniques described in this disclosure. Computing device 1500 includes a processor 1502, memory 1504, an input/output device such as a display 1506, a communication interface 1508, and a transceiver 1510, among other components. The device 1500 may also be provided with a storage device, such as a micro-drive or other device, to provide additional storage. Each of the components 1500, 1502, 1504, 1506, 1508, and 1510, are interconnected using various buses, and several of the components may be mounted on a common motherboard or in other manners as appropriate.

The processor 1502 can execute instructions within the computing device 1500, including instructions stored in the memory 1504. The processor 1502 may be implemented as a chipset of chips that include separate and multiple analog and digital processors. The processor 1502 may provide, for example, for coordination of the other components of the device 1500, such as control of user interfaces, applications run by device 1500, and wireless communication by device 1500.

Processor 1502 may communicate with a user through control interface 1512 and display interface 1514 coupled to a display 1506. The display 1506 may be, for example, a TFT LCD (Thin-Film-Transistor Liquid Crystal Display) or an OLED (Organic Light Emitting Diode) display, or other appropriate display technology. The display interface 1514 may comprise appropriate circuitry for driving the display 1506 to present graphical and other information to a user. The control interface 1512 may receive commands from a user and convert them for submission to the processor 1502. In addition, an external interface 1516 may be provided in communication with processor 1502, so as to enable near area communication of device 1500 with other devices. External interface 1516 may provide, for example, for wired communication in some implementations, or for wireless communication in other implementations, and multiple interfaces may also be used.

The memory 1504 stores information within the computing device 1500. The memory 1504 can be implemented as one or more of a computer-readable medium or media, a volatile memory unit or units, or a non-volatile memory unit or units. Expansion memory 1518 may also be provided and connected to device 1500 through expansion interface 1520, which may include, for example, a SIMM (Single In Line Memory Module) card interface. Such expansion memory 1518 may provide extra storage space for device 1500 or may also store applications or other information for device 1500. Specifically, expansion memory 1518 may include instructions to carry out or supplement the processes described above and may include secure information also. Thus, for example, expansion memory 1518 may be provided as a security module for device 1500 and may be programmed with instructions that permit secure use of device 1500. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1504, expansion memory 1518, memory on processor 1502, or a propagated signal that may be received, for example, over transceiver 1510 or external interface 1516.

Device 1500 may communicate wirelessly through communication interface 1508, which may include digital signal processing circuitry where necessary. Communication interface 1508 may in some cases be a cellular modem. Communication interface 1508 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1510. In addition, short-range communication may occur, such as using a Bluetooth, Wi-Fi, or other such transceiver (not shown). In addition, GPS (Global Positioning System) receiver module 1522 may provide additional navigation- and location-related wireless data to device 1500, which may be used as appropriate by applications running on device 1500.

Device 1500 may also communicate audibly using audio codec 1524, which may receive spoken information from a user and convert it to usable digital information. Audio codec 1524 may likewise generate audible sound for a user, such as through a speaker, e.g., in a handset of device 1500. Such sound may include sound from voice telephone calls, may include recorded sound (e.g., voice messages, music files, etc.) and may also include sound generated by applications operating on device 1500. In some examples, the device 1500 includes a microphone to collect audio (e.g., speech) from a user. Likewise, the device 1500 may include an input to receive a connection from an external microphone.

The computing device 1500 may be implemented in a number of different forms. For example, it may be implemented as a computer (e.g., laptop) 1526. It may also be implemented as part of a smartphone 1528, smart watch, tablet, personal digital assistant, or another similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for operating a social club within an online discussion forum, comprising:
receiving at least one first parameter for the social club;
establishing, at a first time, the social club with a configuration based on the at least one first parameter;
determining, at a second time, a member count of the social club;
comparing the member count to at least one threshold;
automatically selecting at least one second parameter for the social club based on a result of the comparison; and
updating the configuration of the social club based on the at least one second parameter.

2. The method of claim 1, wherein the at least one first parameter is provided by at least one creator of the social club.

3. The method of claim 1, wherein the online discussion forum is configured to host a plurality of users and a portion of those users are members of the social club.

4. The method of claim 3, wherein establishing the social club includes allowing the portion of users who are members of the social club to access the social club.

5. The method of claim 3, wherein the member count represents a total number of users who have access to the social club at the first time.

6. The method of claim 3, wherein the member count represents a total number of users who are actively using the social club at the first time.

7. The method of claim 3, wherein the at least one first parameter and the at least one second parameter correspond to parameters of a plurality of parameters associated with the social club's user experience, and
wherein the plurality of parameters include one or more of the following parameters: a number of social club invites provided to each member, an assignment of administrators for the social club, a quantity of administrators for the social club, notification settings, a format for a chat thread in the social club, or a moderation scheme for the social club.

8. The method of claim 1, wherein automatically selecting the at least one second parameter based on the result of the comparison includes selecting the at least one second parameter in response to the member count exceeding a first threshold.

9. The method of claim 1, wherein automatically selecting the at least one second parameter based on the result of the comparison includes selecting the at least one second parameter in response to the member count falling below a first threshold.

10. A system for operating a social club within an online discussion forum, comprising:
at least one memory for storing computer-executable instructions; and
at least one processor for executing the instructions stored on the memory, wherein execution of the instructions programs the at least one processor to perform operations comprising:
receiving at least one first parameter for the social club;
establishing, at a first time, the social club with a configuration based on the at least one first parameter;
determining, at a second time, a member count of the social club;
comparing the member count to at least one threshold;
automatically selecting at least one second parameter for the social club based on a result of the comparison; and
updating the configuration of the social club based on the at least one second parameter.

11. The system of claim 10, wherein the at least one first parameter is provided by at least one creator of the social club.

12. The system of claim 10, wherein the online discussion forum is configured to host a plurality of users and a portion of those users are members of the social club.

13. The system of claim 12, wherein establishing the social club includes allowing the portion of users who are members of the social club to access the social club.

14. The system of claim 12, wherein the member count represents a total number of users who have access to the social club at the first time.

15. The system of claim 12, wherein the member count represents a total number of users who are actively using the social club at the first time.

16. The system of claim 12, wherein the at least one first parameter and the at least one second parameter correspond to parameters of a plurality of parameters associated with the social club's user experience, and
wherein the plurality of parameters include one or more of the following parameters: a number of social club invites provided to each member, an assignment of administrators for the social club, a quantity of administrators for the social club, notification settings, a format for a chat thread in the social club, or a moderation scheme for the social club.

17. The system of claim 10, wherein automatically selecting the at least one second parameter based on the result of the comparison includes selecting the at least one second parameter in response to the member count exceeding a first threshold.

18. The method of claim 10, wherein automatically selecting the at least one second parameter based on the result of the comparison includes selecting the at least one second parameter in response to the member count falling below a first threshold.

19. A method for operating a social club within an online discussion forum, comprising:
sending invites to a first cohort of users to join the social club, the first cohort of users being selected by at least one creator of the social club;
receiving an acceptance of the invite to join the social club from one or more users of the first cohort of users;
allocating, upon acceptance of the invite, a first predetermined number of invites to each user of the first cohort of users; and
sending invites to a second cohort of users to join the social club, the second cohort of users being selected by the one or more users of the first cohort of users who joined the social club.

20-33. (canceled)

34. A system for operating a social club within an online discussion forum, comprising:
at least one memory for storing computer-executable instructions; and
at least one processor for executing the instructions stored on the memory, wherein execution of the instructions programs the at least one processor to perform operations comprising:
sending invites to a first cohort of users to join the social club, the first cohort of users being selected by at least one creator of the social club;
receiving an acceptance of the invite to join the social club from one or more users of the first cohort of users;
allocating, upon acceptance of the invite, a first predetermined number of invites to each user of the first cohort of users; and
sending invites to a second cohort of users to join the social club, the second cohort of users being selected by the one or more users of the first cohort of users who joined the social club.

35-48. (canceled)
